(19) United States
(12) Patent Application Publication
(10) Pub. No.: US 2025/0362670 A1
(43) Pub. Date: Nov. 27, 2025

(54) DEVICE AND METHOD FOR TESTING A PROCESS

(71) Applicants: Robert Bosch GmbH, Stuttgart (DE); CARNEGIE MELLON UNIVERSITY, Pittsburgh, PA (US)

(72) Inventors: Marco Giani, Stuttgart (DE); Raffaele Romagnoli, Pittsburgh, PA (US)

(21) Appl. No.: 19/215,401

(22) Filed: May 22, 2025

(30) Foreign Application Priority Data
May 24, 2024 (DE) 10 2024 204 801.1

(51) Int. Cl. G05B 23/02

(52) U.S. Cl. CPC G05B 23/024

(57) ABSTRACT

A device and a method for testing a process. A state variable of the process is controllable using a control input from a controller. The method includes determining successive values of the state variables without control input, starting from an initial value of the state variables, and a set of the successive values of the state variables, which can be calculated, until the quadratic Lyapunov function for the value of the state variables reaches a predetermined threshold value, and determining that the process is robust with respect to the set of successive values without control input.

### FIELD

The present invention relates to a device and a method for testing a process.

### BACKGROUND INFORMATION

In a networked control system, a process involving a controlled system is controlled in a control loop by a controller from a remote location via a communication network. A significant challenge for this type of control system is the latency period, i.e., the delay between the controller and the controlled system. Latency may vary over time. This delay can actually destabilize and degrade the performance of the control loop.

### SUMMARY

A method for testing a process, wherein a state variable of the process is controllable using a control input from a controller. According to an example embodiment of the present invention, the method includes determining successive values of the state variables without control input, starting from an initial value of the state variables, and a set of the successive values of the state variables, which can be calculated, until the quadratic Lyapunov function for the value of the state variables reaches a predetermined threshold value, and determining that the process is robust with respect to the set of successive values without control input.

According to an example embodiment of the present invention, the method can comprise determining an array of sets of successive values of the state variables without control input until the quadratic Lyapunov function for the value of the state variables reaches the predetermined threshold value, starting from different initial states of the state variables, and determining that the process is robust with respect to the sets of successive values without control input.

According to an example embodiment of the present invention, the method can comprise guiding the process to the initial value of the state variables using control input.

According to an example embodiment of the present invention, the method can comprise determining the values of the state variables using the process, wherein the process is carried out on a computer-controlled machine.

According to an example embodiment of the present invention, the method can comprise receiving the control input from a remote controller, determining the state variables using the process, and activating a local controller to control the process upon detection that the maximum number of successive values of the control input is missing.

The present invention provides a device for testing a process is configured to carry out the method of the present invention.

A computer program can be provided according to the present invention, wherein the computer program comprises computer-readable instructions that, when executed by a computer, cause the computer to carry out the method of the present invention.

Further examples can be found in the description below and in the figures.

### BRIEF DESCRIPTION OF THE DRAWINGS

FIG. 1 schematically shows a communication network.

FIG. 2 is a process diagram comprising steps of a method for controlling a process using a controller depending on a state variable of the process, according to an example embodiment of the present invention.

FIG. 3 is a flowchart with steps of a method for testing the process, according to an example embodiment of the present invention.

FIG. 4 shows an exemplary system that carries out the process, according to an example embodiment of the present invention.

FIG. 5 shows an exemplary behavior of a quadratic Lyapunov function, according to an example embodiment of the present invention.

### DETAILED DESCRIPTION OF EXAMPLE EMBODIMENTS

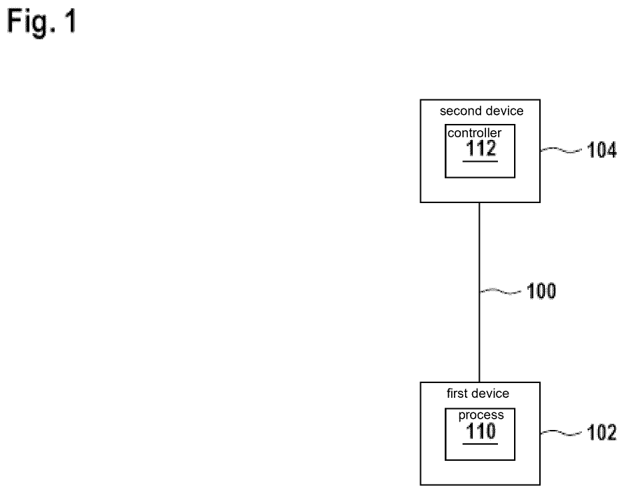

FIG. 1 schematically shows a communication network 100.

The communication network 100 comprises a first device 102 and a second device 104.

The communication network 100 connects the first device 102 and the second device 104.

The communication network 100 can comprise one or more intermediate stations, e.g., switches, between the first device 102 and the second device 104.

The first device 102 is a local device with respect to at least one sensor which monitors the process 110 and with respect to at least one actuator which acts in the process 110. In this context, ‘local’ means that the first device 102 has direct access to the at least one sensor and the at least one actuator. ‘Direct access’ can mean that a delay in access is negligible compared to a delay in the communication network 100.

According to one example, a process 110 is carried out on the first device 102, and a controller 112 for controlling the process 110 is executed on the second device 104.

The process 110 controls a system on a local device, e.g., the first device 102. The local device performs input and/or output operations. For example, the local device reads inputs from sensors to monitor the system or the environment of the system. The local device controls, for example, actuators to control the system. The system can be an industrial machine, a software-defined vehicle, a device in the Internet of Things (IoT), or in the intelligent IoT (IIoT).

For example, the process 110 includes controlling a computer-controlled machine, such as a software-defined vehicle. The controller 112 may be an edge device or a cloud-based controller.

The communication network 100 comprises, for example, a CAN (Controller Area Network) bus. The communication network 100 comprises, for example, a local area network, LAN. The communication network 100 comprises, for example, a wireless local area network, WLAN. The communication network 100 comprises, for example, a wide area network, WAN.

The communication network 100 may include a combination of CAN, LAN, WLAN, WAN.

The first device 102 and the second device 104 may comprise a microcontroller and a memory, in particular a transient and a non-volatile memory. For example, a computer program can be provided on the transient and non-volatile memory, wherein the computer program comprises computer-readable instructions that, when executed by a computer, e.g., the microcontroller, cause the computer to carry out a method for controlling the process 110 using the controller 112.

According to the example, the process 110 is represented and linearized by a system in the form of a discrete state space:

$${x}_{k + 1} = A {x}_{k} + B {u}_{k}$$

where xₖ represents a value of the state variables of the process 110, uₖ represents a value of the control input of the process 110, A represents the system matrix of the process 110, and B represents the input matrix of the process 110.

The system defines the behavior of the process 110.

In the example, the system models a technical system of the real world in the form of a discrete state space.

According to the example, the controller 112 is a controller with state feedback

$${u}_{k} = - K {x}_{k}$$

where K is the control intensification matrix.

The quadratic Lyapunov function for this system is

$$V ( x ) = {x}^{T} P x$$

where P is a positive semidefinite matrix which, assuming that A is asymptotically stable, is derived from

$${( A - B K )}^{T} P ( A - B K ) - P = - Q$$

where Q is a symmetric positive definite matrix.

For example, Q is the identity matrix, i.e., ones on the diagonal elements of the matrix and zeros everywhere else. Using the identity matrix makes calculations easier.

The system is quadratically bounded if

$${x}^{T} P x > η \to {( A {x}_{k} + B K {d}_{k} )}^{T} P ( A {x}_{k} + B K {d}_{k} ) - {x}_{k}^{T} P {x}_{k} < 0 , ∀ ‖ d ‖ \leq δ and ∀ k \geq 0$$

where η is a threshold value and dₖ is a disturbance.

The quadratic boundedness property ensures robustness with respect to limited disturbances, since for every value outside the ellipsoid,

$${ε}_{η} = \{ x ∈ {ℝ}^{n} \vert {x}^{T} P x \leq η \}$$

the controller 112 is able to counteract the effects of the disturbance dₖ.

According to the example, the disturbance dₖ is a missing value u of the control input 206. The value u of the control input 206 may be missing due to problems in the communication network 100.

According to the example, the disturbance dₖ is acceptable until the value V(x) of the quadratic Lyapunov function exceeds the threshold value η, i.e., V(x)>η.

For example, a latency of the communication network 100 is modeled as disturbances dₖ, and as long as the disturbances dₖ are limited, the controller 112 restores the process 110, i.e., the system, to stability.

Instead of latency, or in addition to latency, the disturbances dₖ can be used to model and monitor the network delay of the communication network 100, or to model uncertainties or other disturbances.

In the absence of updates, the system can be described as an asymptotically stable system that is subjected to an external disturbance dₖ

$${x}_{k + 1} = {A}_{f} {x}_{k} + B K {d}_{k}$$

wherein

$${A}_{f} = ( A - B K )$$

According to the example, the states of the process 110 are measurable, observable or estimable.

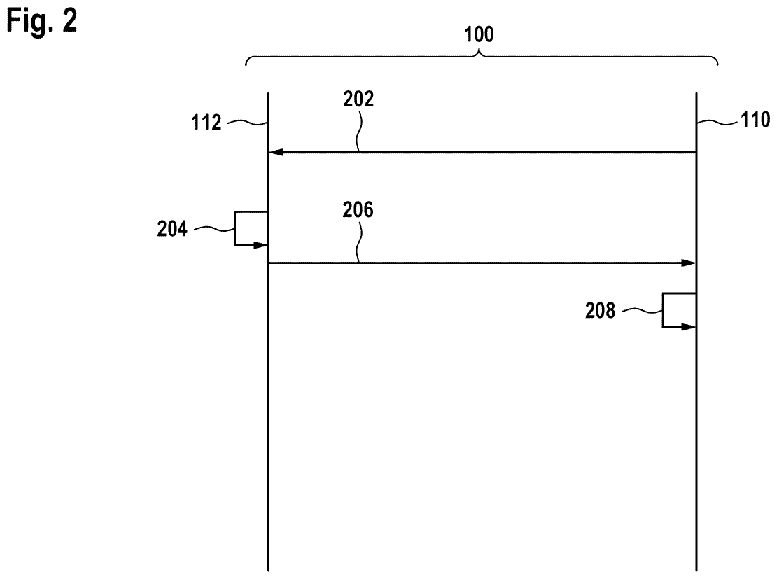

FIG. 2 is a process diagram comprising steps of the method for controlling the process 110 using the controller 112 depending on a state variable 202 of the process 110.

In the example, the process 110 sends a value x of the state variables 202 via the communication network 100 to the controller 112.

In a step 204, the controller 112 determines a value u of a control input 206 for the process 110 depending on the value x of the state variables 202.

In the example, the controller 112 sends the value u of the control input 206 to the process 110 via the communication network 100.

In a step 208, the process 110 is carried out depending on the received value u of a control input 206.

The steps 202, 204, 206, 208 are carried out cyclically and repeatedly when the process 110 is controlled using the controller 112.

During the control, it can happen that the process 110 does not receive a value uᵢ of the control input 206 in a cycle i. According to the example, the process 110 is configured to retain the previously received value uᵢ₋₁ of the control input 206 if the process 110 does not receive a value uᵢ of the control input 206.

During the control, it can happen that the process 110 does not receive a plurality of successive values uᵢ₋ₖ, . . . , uᵢ of the control input 206. In this case, the process 110 is configured to retain the last received value uᵢ₋ₖ of the control input 206.

Due to a disturbance of the communication network 100, the process 110 may not be able to receive the value uᵢ or the successive values uᵢ₋ₖ, . . . , uᵢ of the control input 206. The fact that the value uᵢ or the successive values uᵢ₋ₖ, . . . , uᵢ of the control input 206 are not received can lead to system instability.

To observe whether the system can be pushed beyond the limits of ε_{η}, the update of the control input 206 is stopped in a test j for a set kⱼ of successive values uᵢ₋ₖ_{ⱼ}, . . . , uᵢ of the control input 206.

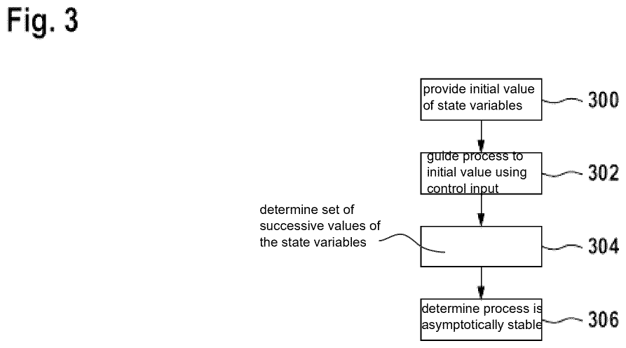

FIG. 3 shows a flowchart with steps of a method for testing the process 110.

In the process 110, the state variable 202 of the process 110 is controllable using the control input 206 from the controller 112.

In the example, the test is carried out using a system in the form of a discrete state space in the test. The test can be carried out using the actual system in the test or in a simulation of the actual system, wherein the system is utilized in a discrete state space form, instead of utilizing the actual system in the test.

According to one example, the state variable 202 comprises at least one state of the computer-controlled machine, and the values of the state variables 202 are determined using the process 110 while the process 110 is carried out on the computer-controlled machine.

The method for testing comprises a step 300.

Step 300 comprises providing an initial value x₀ of the state variables 202.

Step 300 comprises providing a predetermined threshold value η∈ [symbol] for the quadratic Lyapunov function V(x) for the values x of the state variables 202. The method in the example is based on a predefined robustness for the system. The value of η is, for example, chosen to match the predefined robustness.

For example, an initial state x₀ is provided where the value of the quadratic Lyapunov function V(x₀) is close to the predetermined threshold value η.

In this sense, the system is initialized very close to the limit of its robustness in order to estimate the worst-case scenario, namely a delay that occurs while the system is operating at the edge of its robustness.

For an algorithm for numerically testing the robustness of the system, a threshold value η′ can be chosen that is smaller than the threshold value η near the limit.

For example, an operator of the process knows, for a process, the maximum permissible deviation from the initial state x₀ that is tolerable. For example, in the case of a pendulum on a cart, it is undesirable for the cart to move a certain distance from the center, or for the pendulum rod to be inclined by more than a certain angle. In general, such deviations are known because they are linked to performance or quality in actual processes.

If this initial state x₀ is known, the Lyapunov function V(x₀) is calculated and the threshold value η′ for the algorithm is determined depending on the Lyapunov function V(x₀), in particular V(x)=η′. The algorithm examines the system at the edge of the threshold value η′ and therefore does not lose stability, since threshold value η′<threshold value η.

The method for testing comprises a step 302.

Step 302 comprises guiding the process 110 to the initial value x₀ of the state variables 202 using the control input 206.

The method for testing comprises a step 304.

Step 304 comprises determining successive values of the state variables 202 without control input 206, starting from the initial value of the state variables 202.

Step 304 comprises determining a set of successive values of the state variables 202, which can be calculated, until the quadratic Lyapunov function V(x) for the value x of the state variables 202 reaches the predetermined threshold value η′.

According to one example, step 304 comprises determining an array kᵢ of sets of successive values of the state variables 202 without control input 206, starting from different initial states of the state variables 202.

An exemplary algorithm for numerically testing the robustness of the system is provided below.

```
Input: η′, x₀, N Output: kⱼ, V(xₖ)
k ← 1
xₖ ← x₀
for j = 1 to N do
  if V(xₖ) < η′ then
    xₖ₊₁ ← Axₖ − BKx₀
    k ← k + 1
  else
    xₖ₊₁ = A_{f}xₖ
    kⱼ ← k
    k ← 1
  end if
  xₖ ← xₖ₊₁
  $V ( {x}_{k} ) ← {x}_{k}^{T} {Px}_{k}$
end for
```

The algorithm runs over N time steps. The control input is updated if V(xₖ)<η′. Every time the control input is updated, the algorithm stores the value of k in the array kᵢ, which represents the maximum sequence of missing values of the control input 206 before the value of the state variables 202 leaves the ellipsoid ε_{η′}.

The method for testing comprises a step 306.

Step 306 comprises determining that the process 110 is asymptotically stable for the maximum set of successive missing values of the control input 206 when the set of successive values of the state variables reaches the maximum set or differs from the maximum set by less than a predetermined tolerance.

According to one example, the controller 112 is a remote controller, and a local controller is available to control the process 110. The method for controlling the process 110 in this example can comprise receiving the control input 206 from the remote controller 112 and determining the state variable 202 using the process 110. The method for controlling the process 110 comprises, for example, activating the local controller for controlling the process 110 upon detection that the maximum set k* of successive values of the control input 206 is missing.

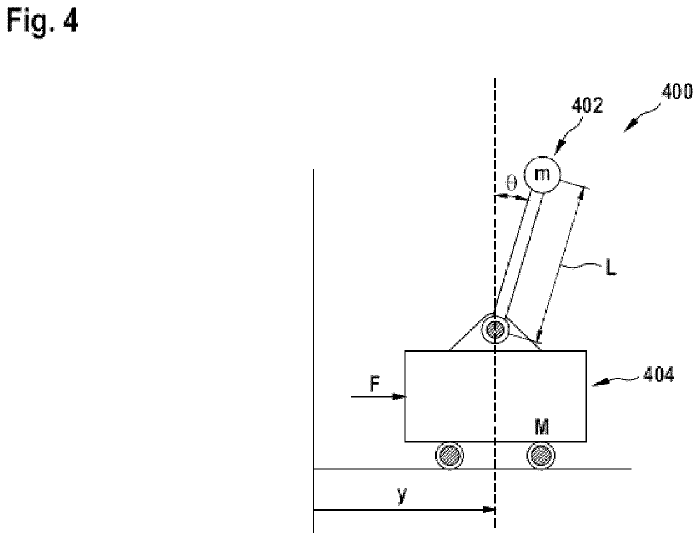

FIG. 4 shows an exemplary system 400 that carries out the process, namely an inverted pendulum 400.

The physical model of the inverted pendulum is given by the following system of second-order ordinary differential equations:

$$\begin{matrix}L \ddot{Θ} = g sin Θ - \ddot{y} cos Θ - \frac{k}{m} L \dot{Θ} \\ ( M + m ) \ddot{y} = mL {\dot{Θ}}^{2} sin Θ - m L \ddot{Θ} cos Θ - b \dot{y} + F\end{matrix}$$

where the mass of the rope is negligible, and
m [Kg]: mass of the pendulum 402,
M [Kg]: mass of the cart 404,
L [m]: length of the pendulum from the pivot to the pendulum body,
b [Ns/m]: friction coefficient of the cart 404,
k [Nsm/Rad]: friction coefficient of the pendulum 402,
θ [Rad]: angle formed by the pendulum with the vertical axes passing through the pivot, θ=0 represents the upright position,
y [m]: position of the cart 404,
F [N]: force exerted on the cart 404,
g=9.81 [m/s²]: acceleration due to gravity.

The inverted pendulum 400 is modeled for the state space variables x¹=θ, x²=\dot{θ}, x³=y, x⁴=\dot{y} and approximations such as 0≈0

$$\dot{x} = A x + B F$$

wherein

$$A = [ \begin{matrix}0 & 1 & 0 & 0 \\ \frac{\overline{M} g}{LM} & - \frac{\overline{M} ( \frac{kL}{m} )}{LM} & 0 & \frac{b}{LM} \\ 0 & 0 & 0 & 1 \\ - \frac{gm}{M} & \frac{( \frac{k}{m} )}{M} & 0 & - \frac{b}{M}\end{matrix} ]$$

where M̅=M+m and the control input u is the force F exerted on the cart 404.

$$B = {[ \begin{matrix}0 & - \frac{1}{ML} & 0 & \frac{1}{M}\end{matrix} ]}^{T}$$

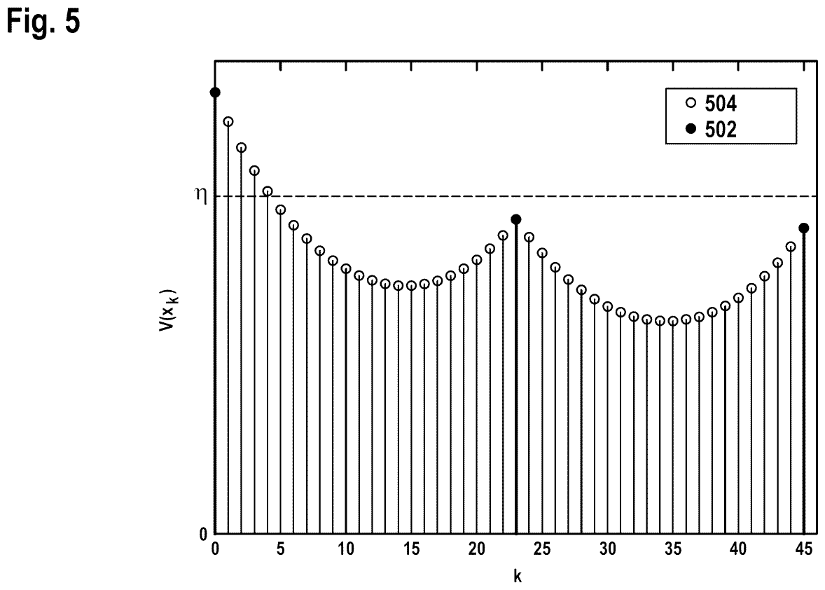

FIG. 5 shows an exemplary behavior of the quadratic Lyapunov function V(xₖ) for the inverted pendulum in the test for a threshold value η. In the example, the threshold value is η=10. FIG. 5 shows 23 successive disturbances dₖ, which are caused by a missing value u of the control input. The control input in the example is the force F exerted on the cart 404. The disturbances in the example are caused by the missing force F exerted on the cart 404.

According to the example, a received control input 502 is followed by 22 successive missing control inputs 504. FIG. 5 shows the time steps k=0, . . . , 45.

In the case of 22 successive missing control inputs 504, the test confirms that the exemplary system 400 is asymptotically stable.

FIG. 5 shows a first sequence of 22 successive missing control inputs 504 between a first received control input 502 and a second received control input 502. FIG. 5 shows a second sequence of 22 successive missing control inputs 504 between the second received control input 502 and a third received control input 502.

1-7. (canceled)

8. A method for testing a process, wherein a state variable of the process is controllable using a control input from a controller, the method comprising the following steps:
determining successive values of the state variables without control input, starting from an initial value of the state variables, and a set of the successive values of the state variables, which can be calculated, until a quadratic Lyapunov function for the value of the state variables reaches a predetermined threshold value; and
determining that the process is robust with respect to the set of successive values without control input.

9. The method according to claim 8, further comprising:
determining an array of sets of successive values of the state variables without control input until the quadratic Lyapunov function for the value of the state variables reaches the predetermined threshold value, starting from different initial states of the state variables, and determining that the process is robust with respect to the sets of successive values without control input.

10. The method according to claim 8, further comprising guiding the process to the initial value of the state variables using control input.

11. The method according to claim 8, further the values of the state variables are determined using the process, wherein the process is carried out on a computer-controlled machine.

12. The method according to claim 8, further comprising:
receiving the control input from a remote controller;
determining the state variables using the process; and
activating a local controller for controlling the process upon detection that a maximum number of successive values of the control input is missing.

13. A device for testing a process, wherein the device is configured to test a process, wherein a state variable of the process is controllable using a control input from a controller, the device configured to:
determine successive values of the state variables without control input, starting from an initial value of the state variables, and a set of the successive values of the state variables, which can be calculated, until a quadratic Lyapunov function for the value of the state variables reaches a predetermined threshold value; and
determine that the process is robust with respect to the set of successive values without control input.

14. A non-transitory computer-readable medium on which is stored a computer program, including computer-readable instructions for testing a process, wherein a state variable of the process is controllable using a control input from a controller, the instructions, when executed by a computer, causing the computer to perform the following steps:
determining successive values of the state variables without control input, starting from an initial value of the state variables, and a set of the successive values of the state variables, which can be calculated, until a quadratic Lyapunov function for the value of the state variables reaches a predetermined threshold value; and
determining that the process is robust with respect to the set of successive values without control input.
